(19) United States
(12) Patent Application Publication
(10) Pub. No.: US 2012/0024900 A1
(43) Pub. Date: Feb. 2, 2012

(54) MOUNTING MEDIA DEVICE

(76) Inventor: Sam Bhatia, Omaha, NE (US)

(21) Appl. No.: 13/195,995

(22) Filed: Aug. 2, 2011

Related U.S. Application Data
(60) Provisional application No. 61/369,951, filed on Aug. 2, 2010.

(51) Int. Cl. B67D 7/06; B65D 83/00; G01F 11/00

(52) U.S. Cl. 222/179; 222/389; 222/394

(57) ABSTRACT

A mounting media device for application of mounting media to a specimen positioned on a slide before placement of a cover slip. The mounting media device includes an enclosure element, a foot pedal element, and a syringe element. The enclosure element further includes an air compressor component and a dispenser component positioned within the enclosure element. The air compressor component provides air at a specified pressure to the dispenser component. The foot pedal element is triggered to dispense air at a specified pressure from the dispenser component into the syringe element thereby releasing the mounting media from the syringe element onto the specimen positioned on the slide before placement of a cover slip. The foot pedal element may also be depressed so that a user may manually control the release of air from the dispenser component to the syringe element.

### PRIORITY NOTICE

This Application claims the benefit of Provisional U.S. patent application Ser. No. 61/369,951 filed Aug. 2, 2010.

### FIELD OF THE INVENTION

The invention relates generally to microscopy and mounting media positioned between a slide and a cover slip used for specimens. The invention relates to a mounting media device with an automatic mode and a manual mode thereby combining the techniques of automated and manual application of mounting media to specimens before placement of cover slips.

The present invention is discussed in the following largely with reference to microscopy related to tissue specimens of the medical industry, but the present invention is applicable to a variety of specimens within a variety of microscopy industries, each of which may utilize or benefit from a dual-mode mounting media device, for example, archaeology, biology, geophysics, materials science, life science, and others.

### BACKGROUND OF THE INVENTION

Use of mounting media is a common and effective way for preserving and protecting tissue specimens, as well as viewing the specimens with a microscope. A microscopic slide and a cover slip are used for tissue specimens, which are positioned between the slide and cover slip. A cover slip is a thin flat piece of transparent material, usually glass or plastic. It is also contemplated that fused quartz cover slips may be used where ultraviolet transparency is required such as for fluorescence microscopy.

The cover slip serves many functions, including keeping the specimen pressed flat and of even thickness on the slide, holding the specimen in place on the slide by its weight or by surface tension, protecting the specimen from dust and preventing accidental contact. Additionally, the cover slip protects the lens of the microscope from contacting the specimen.

In certain instances, the cover slip is sealed or glued to the slide by mounting media in order to prevent contamination and decay of the specimen. Typically, mounting media is applied to a specimen positioned on a slide before placement of the cover slip. A number of mounting media are currently in use such as sealants, laboratory preparations, adhesives, clear nail polish, and “varlap”—an equal part mixture of vaseline, lanolin, and paraffin.

Applying mounting media to a specimen may be performed manually by hand, or in bulk by an automated machine. Current dispensers of mounting media come in many forms. Many automated dispensers sit on a surface such as a countertop and require the loading of a basket in order for the mounting media to be applied to the specimen and then cover slipped. The bulk of current automated dispensers can handle multiple mounting media at once and include a hydraulic arm along with a needle tip to dispense the mounting media.

There are certain situations when it is preferable to manually apply mounting media to a specimen before manually placing the cover slip. Typically, manual cover slipping is performed with specimens that are time sensitive or high risk. In these instances, setting up an automated dispenser for mounting media may be time-consuming. Furthermore, specimens of a small sample size provide limited room for error—a risky situation should the automated dispenser malfunction.

Manually applying mounting media requires very few materials: a squeeze bottle containing mounting media such as sealant or glue, or a flask with a wooden applicator. The disadvantages of manually applying mounting media to a specimen and manually placing a cover slip to a slide include, for example, clogging of the sealant or glue, accidental spills, and the sealant or glue drying up if not properly stored.

There is currently no dual-mode device available that combines the techniques of automated and manual application of mounting media to specimens. It would be desirable to have a device that includes two modes—automatic and manual. The present invention satisfies this demand.

### SUMMARY OF THE INVENTION

The present invention is a mounting media device for application of mounting media to a specimen positioned on a slide before placement of a cover slip. The mounting media device includes an enclosure element, foot pedal element, and syringe element. An air compressor component and a dispenser component are positioned within the enclosure element. The dispenser component receives air from the air compressor component and dispenses air at a specified pressure according to a programmed time sequence. The foot pedal element is triggered to dispense air from the dispenser component into the syringe element thereby releasing the mounting media from the syringe element onto the specimen positioned on the slide. The mounting media may be any liquid, cream, liniment, oil, lotion, or gel.

The present invention is a mounting media device with an automatic mode and a manual mode thereby combining the techniques of automated and manual application of mounting media. A user may use each mode exclusively or in combination.

The enclosure element may be made of any material such as stainless steel and may be of any configuration to contain the various components of the device described more fully below. In one embodiment, the enclosure element is cube-shaped with six sides. It is contemplated that the enclosure element includes an openable door member positioned on one side, wherein the openable door member may include a locking feature. In another embodiment, the enclosure element may further include one or more handle members to enable portability of the device. In yet another embodiment, the enclosure element may further include one or more air vent members to ventilate with or without a charcoal filter and control the temperature of the device. In another embodiment, the enclosure element includes a control panel member positioned on one side of the enclosure element. The control panel member includes one or more unit controls such as power switch, automatic/manual switch, dispensing time digital readout, and pressure gauge.

The air compressor component is positioned within the enclosure element and provides pressure that flows into the dispenser component. The dispenser component is also positioned within the enclosure element and includes a valve member. The dispenser component, more particularly the valve member, is activated by a foot pedal element—a lever that is activated by a user's foot—and controls the amount of air and pressure provided to a syringe element. It is also contemplated that the dispenser component may be activated to release air by hand. The dispenser component includes an electronic bladder mechanism to dispense the air through the valve member, although any manual or gravity mechanism is contemplated such as a pump or spray.

The syringe element is a simple piston pump consisting of a plunger member that fits tightly in a tube member. The plunger member can be pulled and pushed along the inside of the tube member allowing the syringe element to take in and expel mounting media through an orifice member at the end of the tube element. In one embodiment, the orifice member is a needle tip, which may be made of plastic or metal. It is contemplated that the syringe element is of any size and made of plastic, although any material is contemplated. It is also contemplated that the syringe element is disposable and may further be sterile for certain applications such as those that pertain to Deoxyribonucleic Acid (“DNA”). The syringe element may also be preloaded with mounting media for simplified use with the device.

The mounting media device includes an automatic mode and a manual mode. Air according to a specified pressure is released from the air compressor component into the dispenser component. The automatic mode allows a user to program an exact time sequence to which the dispenser component dispenses air of a specified pressure. In the automatic mode, when the foot pedal element is triggered, air from the dispenser component is released through the valve member and supplied to the syringe element at the programmed time sequence. The syringe element includes mounting media that is released from the needle tip onto a specimen positioned on a slide. The slide and specimen are then covered by a cover slip.

The manual mode allows the user to control the dispenser component by hand so long as the foot pedal element is depressed. In the manual mode, while the foot pedal element is triggered, a user may manually control the release of air from the dispenser component to the syringe element. The mounting media within the syringe element is released from the needle tip onto a specimen positioned on a slide and the slide and specimen are covered by a cover slip.

An object of the present invention is to provide a device that replaces a manual application of mounting media and cover slipping.

Another object of the present invention is to provide a device that is lower in cost than current devices.

Another object of the present invention is to provide a device that is foot pedal controlled.

Another object of the present invention is to provide a device with syringes of mounting media. Another object of the present invention is to provide a device with disposable syringe tips.

Another object of the present invention is to provide a device that is self-contained.

Another object of the present invention is to provide a device that low pressure.

These and other aspects, features, and advantages of the present invention will become more readily apparent from the attached drawings and the detailed description of the preferred embodiments, which follow.

### BRIEF DESCRIPTION OF THE DRAWING

The preferred embodiments of the invention will be described in conjunction with the appended drawings provided to illustrate and not to the limit the invention, where like designations denote like elements, and in which:

FIG. 1 illustrates one embodiment of the enclosure element of the mounting media device according to the present invention;

FIG. 2 illustrates one embodiment of the control panel component of the mounting media device according to the present invention;

FIG. 3 illustrates one embodiment of the interior of the mounting media device according to the present invention;

FIG. 4 illustrates one embodiment of the syringe element of the mounting media device according to the present invention; and

FIG. 5 illustrates one embodiment of the foot pedal control component of the mounting media device according to the present invention.

### DETAILED DESCRIPTION OF THE PREFERRED EMBODIMENT

The mounting media device includes an enclosure element, foot pedal element and syringe element. The enclosure element further includes an air compressor component and a dispenser component. The air compressor component and the dispenser component are positioned within the enclosure element. The mounting media device includes an automatic mode and a manual mode.

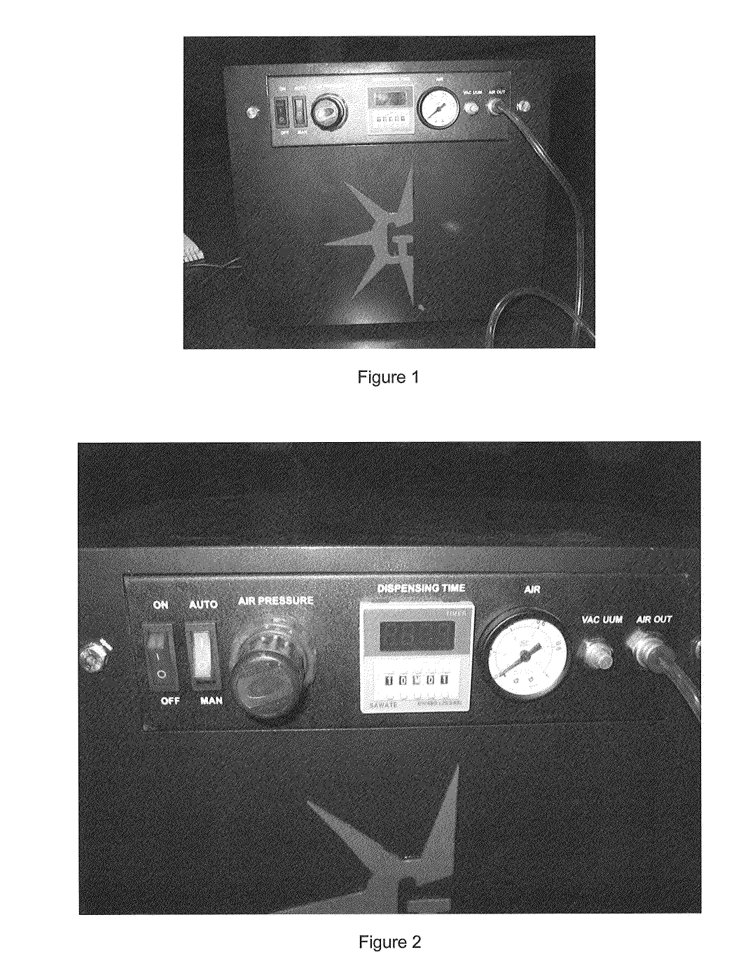

FIG. 1 illustrates the enclosure element of the mounting media device according to the present invention. As shown, the enclosure element is made of a stainless steel material and is cube-shaped with six sides. On one side, the enclosure element includes an openable door member with a locking feature. On another side, the enclosure element includes one or more handle members for easy maneuverability of the device. Additionally, another side of the enclosure element includes one or more air vent members to ventilate and control the temperature of the device. The enclosure element also includes a control panel member positioned on the front side of the enclosure element described more fully with respect to FIG. 2.

FIG. 2 illustrates the control panel component of the mounting media device according to the present invention. The control panel member includes one or more unit controls such as power switch, automatic/manual switch, dispensing time digital readout, and pressure gauge. The mounting media device is powered by two power cords, although it is contemplated that both power cords may be integrated into one cord. One cord provides power to the entire mounting media device and the other cord provides power to the air compressor component. The power unit control communicates whether or not power is provided to the device including the air compressor component.

The automatic/manual switch communicates the operating mode of the mounting media device. The device operates in manual mode with the switch in the lower position and the device operates in automatic mode when the switch is in the upper position. In manual mode, a user may manually control the release of air from the dispenser component to the syringe element so long as the foot pedal element is triggered. In automatic mode, the user can program an exact time sequence to which the dispenser component dispenses air at a specified pressure into the syringe element. When the foot pedal element is triggered, air from the dispenser component is released and supplied to the syringe element at the programmed time sequence.

The pressure unit control can be manipulated to vary the amount of pressure in the manual mode. For example, manipulating the pressure unit control to the right increases pressure and manipulating the pressure unit control to the left decreases pressure. In the automatic mode, the preferred embodiment includes pressure at 55 pounds per square inch (“psi”) such that the compressor component continuously cycles to maintain the pressure of 55 psi.

The dispensing time digital readout shows the numerical value of the programmed time. In one embodiment, the digital readout can display the numerical count up to the programmed time. The dispensing time digital readout further includes a time control adjuster for automatic mode. The time control adjuster allows a timer to be set designated in hours, seconds and minutes. The time control adjuster may further allow a user to select a predetermined timer, such as a timer numbered from 1 to 9.

The pressure gauge provides readings for two pressures: the air compressor component and the entire mounting media device. In one embodiment, the pressure gauge illustrates pressure for the air compressor component in the range of 0-50 psi and the pressure gauge illustrates pressure for the mounting media device in the range of 0-100 psi. In another embodiment there is no gauge on device.

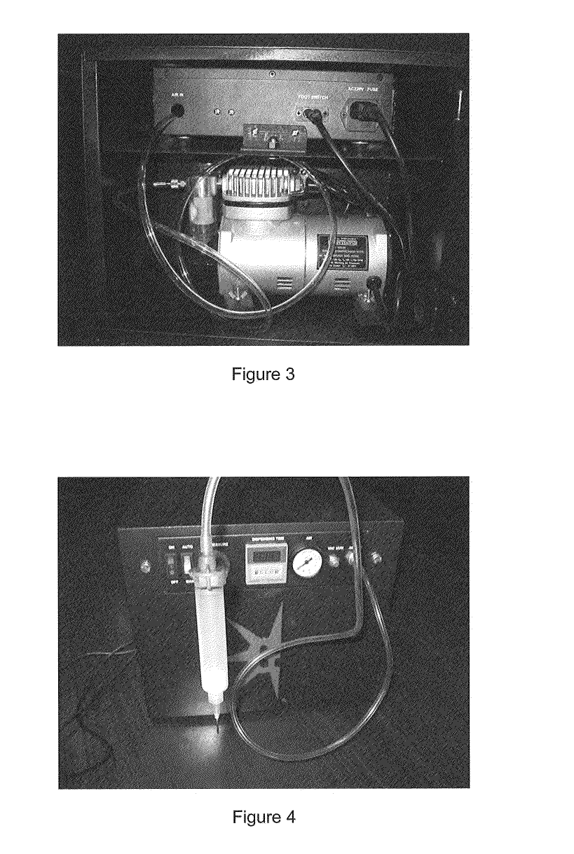

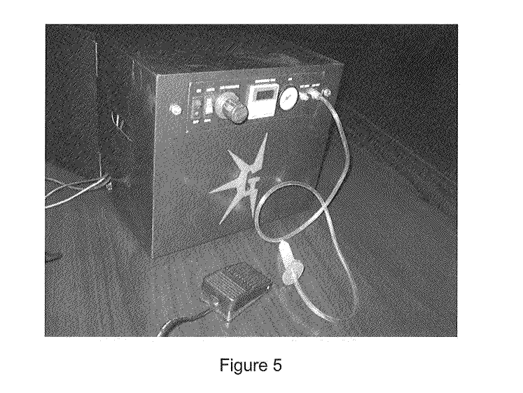

FIG. 3 illustrates the interior of the enclosure element of the mounting media device according to the present invention. As shown in FIG. 3, the air compressor component is mounted below dispensing component. The air compressor component provides air at a specified pressure that flows into the dispenser component. The dispenser component includes a valve member that is activated by a foot pedal element (see FIG. 5) and controls the amount of air and pressure provided to the syringe element.

FIG. 4 illustrates the syringe element including needle tip of the mounting media device according to the present invention. The syringe element is a simple piston pump consisting of a plunger member that fits tightly in a tube member. The syringe element includes mounting media. In one embodiment, it is contemplated that the mounting media is pre-packaged into 10 ml syringes with disposable needle tips. In another embodiment the mounting media is transferred from a sealed jar to syringe delivery system. The mounting media may be any liquid, cream, liniment, oil, lotion, or gel.

The mounting media device includes an automatic mode and a manual mode. FIG. 5 illustrates the syringe element and the foot pedal control component of the mounting media device according to the present invention. Air according to a specified pressure is released from the air compressor component into the dispenser component. The automatic mode allows a user to program an exact time sequence to which the dispenser component dispenses air of a specified pressure. In the automatic mode, when the foot pedal element is triggered, air from the dispenser component is released through the valve member and supplied to the syringe element at the programmed time sequence. The syringe element includes mounting media that is released from the needle tip onto a specimen positioned on a slide. The slide and specimen are then covered by a cover slip.

The manual mode allows the user to control the dispenser component by hand so long as the foot pedal element is depressed. In the manual mode, while the foot pedal element is triggered, a user may manually control the release of air from the dispenser component to the syringe element. The mounting media within the syringe element is released from the needle tip onto a specimen positioned on a slide and the slide and specimen are covered by a cover slip.

The described embodiments are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. A mounting media device for application of mounting media to a specimen positioned on a slide before placement of a cover slip, comprising:
an enclosure element including an air compressor component and a dispenser component, wherein said dispenser component receives air from said air compressor component;
a foot pedal element; and
a syringe element including the mounting media, wherein said foot pedal element is triggered to dispense air from said dispenser component into said syringe element thereby releasing the mounting media from said syringe element onto the specimen positioned on the slide.

2. The mounting media device of claim 1, wherein the air from said dispenser component is dispensed into said syringe element at a specified pressure.

3. The mounting media device of claim 1, wherein the air from said dispenser component is dispensed into said syringe element according to a programmed time sequence.

4. The mounting media device of claim 1, wherein said enclosure element comprises one or more handle members to enable portability of the device.

5. The mounting media device of claim 1, wherein said enclosure element further comprises a control panel member.

6. The mounting media device of claim 5, wherein said control panel member includes one or more unit controls selected from the group of power switch, automatic/manual switch, dispensing time digital readout, and pressure gauge.

7. The mounting media device of claim 1, wherein said syringe element tip is disposable.

8. The mounting media device of claim 1, wherein said foot pedal element is depressed to operate the device in a manual and automatic mode.

9. The mounting media device of claim 8, wherein the air dispensed from said dispenser component into said syringe element is manually controlled.

10. The mounting media device of claim 1, wherein said enclosure element further comprises one or more air vent members to ventilate and control the temperature of the device with a charcoal filter.
